(19) United States
(12) Patent Application Publication
(10) Pub. No.: US 2021/0171177 A1
(43) Pub. Date: Jun. 10, 2021

(54) Airborne Platform Vehicle

(71) Applicant: William J. Neff, Sandy, UT (US)

(72) Inventor: William J. Neff, Sandy, UT (US)

(21) Appl. No.: 16/703,026

(22) Filed: Dec. 4, 2019

(51) Int. Cl. B64B 1/06; B64B 1/40; B64B 1/58; B64B 1/24; B64B 1/12; B64B 1/20; B64B 1/70; B64B 1/22

(52) U.S. Cl. CPC B64B 1/06; B64B 1/40; B64B 1/58; B64B 1/22; B64B 1/12; B64B 1/20; B64B 1/70; B64B 1/24

(57) ABSTRACT

An airborne platform vehicle comprising an aircraft with a platform affixed to the top side providing for a multipurpose airborne platform is disclosed. The airborne platform vehicle comprising a platform affixed to the top side of an aircraft or airship providing accessibility to the platform from either inside or outside the aircraft. The aircraft itself being able to float or fly by virtue of the lighter than air gas inside the body of the aircraft or with assisted lift from wings, being propelled by a ducted fan, propeller drive system, or otherwise and having a power source from which to power the drive system. The airborne platform vehicle being capable of movement and remaining upright through the use of ballast, propellers, ducted fans, vector thrusters, wings, fins, and/or rudders. The airborne platform vehicle itself being able to take-off and land as well as stay afloat for long durations in a stationary or non-stationary position.

### FIELD OF THE INVENTION

This disclosure relates to an airborne platform affixed to a rigid dirigible-like structure from which to conduct activities in the air, allowing for landing and launching of aircraft, transporting people and items, and conducting surveillance and other operations.

### BACKGROUND OF THE INVENTION

Currently, the principal approaches for practical transportation of people, product, and supplies across bodies of water are ships at sea and airplanes in the air; however, both consume a considerable amount of fuel for propulsion and more often in the case of airplanes have relatively small cargo bays limiting the size of cargo being shipped.

In many designs of cargo ships and airplanes, the cargo is contained in enclosed areas (e.g., cargo holds, containers, crates, etc.) and active use of the transported item during shipment is not permissible or feasible.

One specific need is for military aircraft, manned or unmanned, to have a platform on which to land to refuel or re-arm and then continue their operations.

It is therefore desirable to have a vehicle with trans-ocean, or otherwise airborne capabilities, which consist of a large platform or deck from which to perform active operations from while in flight or en route to a destination or hovering while maintaining a presence in a region from which to conduct activities. The large platform may be configured to serve as a deck or runway from which aircraft (e.g., airplanes, helicopters, or otherwise) may take-off or land. This present invention provides for a top deck structure to be affixed to the rigid frame of a dirigible-like aircraft. This platform structure may contain cabins for personnel, storage space for transporting items, and a flat top deck from which to conduct operations. This aircraft's propulsion system may comprise of ducted fans or propellers for driving and steering the vehicle. This propulsion system may be attached to the lower body of the dirigible-like aircraft or to the upper platform structure. The propulsion system may be electric, mechanical, or a hybrid with the power source coming from batteries, engines, gas, and/or nuclear power.

### SUMMARY

The following implementations and aspects thereof are described and illustrated in conjunction with systems, machines, and methods that are meant to be exemplary and illustrative, not necessarily limiting in scope. In various implementations one or more of the above-described problems have been addressed, while other implementations are directed to other improvements.

Beneficially, the airborne platform according to the invention disclosed herein allows for travel in the air by virtue of the lighter than air gas inside the body of the aircraft or with assisted lift from wings, being propelled by a ducted fan or propeller drive system. The airborne platform itself being able to vertically take-off and land as well as stay afloat for long durations.

The invention advantageously provides a top deck or runway platform which is accessible from the compartments below the deck. Compartment covers may be removed so those on deck can retrieve items stored below the deck structure. The interior frame of the aircraft carrying the platform may have lifts (cable, hydraulic, or otherwise) to deliver items from the cargo areas below deck to the deck top side.

Firstly, in various embodiments, the invention is implemented as using strong albeit lightweight trusses to form the body and support the top deck of the aerial platform.

Additionally, in various embodiments, the top deck is built of a strong lightweight composite that is sufficiently strong to support the impact and weight of various operations conducted on its surface, including, but not limited to the landing and taking-off of aircraft, drones, rockets, and the other items.

In various embodiments, the airborne platform may resemble an airship aircraft carrier, which is a combination of a heavy-lift dirigible and a carrier deck or runway mounted on the top providing an ‘aircraft carrier in the sky’ where aircraft can land, refuel, re-arm, and take off again, or if deck space is available, land and transported until relaunched, or transported below deck. This airship aircraft carrier would be capable of holding jet fuel in tanks in the cargo bay that can be pumped up to the deck for refueling. Armaments, food, and other supplies may also be held below deck in the cargo bay, which also beneficially acts as ballast.

In various embodiments, the body of aircraft supporting the airborne platform is a sideways oval, which helps prevent roll-over due to the heavy deck and cargo on top. The airship body has large rudders, side fins, and vector thrust engines to steer the ship as well as also providing stability. Ballast can also be lowered below the airborne platform vehicle to provide a lower center of gravity to additionally assist in stability.

In various embodiments, the airship has a cable lift platform to enable aircraft, people, or supplies to be lowered from the deck down into the cargo bay and vice versa. Cargo area, fuel tanks, cabins for personnel may also be on the inside of the body of the airship which supports the platform, or to act more efficacious as ballast they may be under the body of the airship supporting the platform, the opposite side of the airship's platform, similar to how the cockpit for blimp-type aircraft is under the blimp structure.

These and other advantages will become apparent to those skilled in the relevant art upon a reading of the following descriptions and a study of the several examples of the drawings.

### BRIEF DESCRIPTION OF THE DRAWINGS

The present invention can be put into practice in various ways, but embodiments will now be described by way of example only with reference to the accompanying drawings in which:

FIG. 1 shows an illustrative embodiment of an airborne platform vehicle with the platform shown here as a runway for aircraft to land on.

FIG. 2 shows an illustrative embodiment of an airborne platform vehicle with the platform shown here as a landing pad accessible to vertical take-off and landing aircraft.

FIG. 3 shows an illustrative embodiment of an airborne platform vehicle with the platform shown here as containing cabins or rooms for transporting people.

FIG. 4 shows an illustrative embodiment of a cross-section of the interior framework of an airborne platform vehicle including lifts or elevators to facilitate with movement of cargo from top deck to the lower cargo hold area.

### DETAILED DESCRIPTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, any claims herein are not to be limited to that embodiment. Moreover, any such claims are not to be read restrictively unless there is clear and convincing evidence manifesting a certain exclusion, restriction, or disclaimer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art.

One or more embodiments of an airborne platform capable of staying afloat for long periods of time or an airborne platform vehicle capable of staying afloat and steering can be used in aerial operations since the platform or vehicle has the self-contained ability to overcome the weight of the vehicle and load necessary to provide lift and airborne maneuvering capabilities.

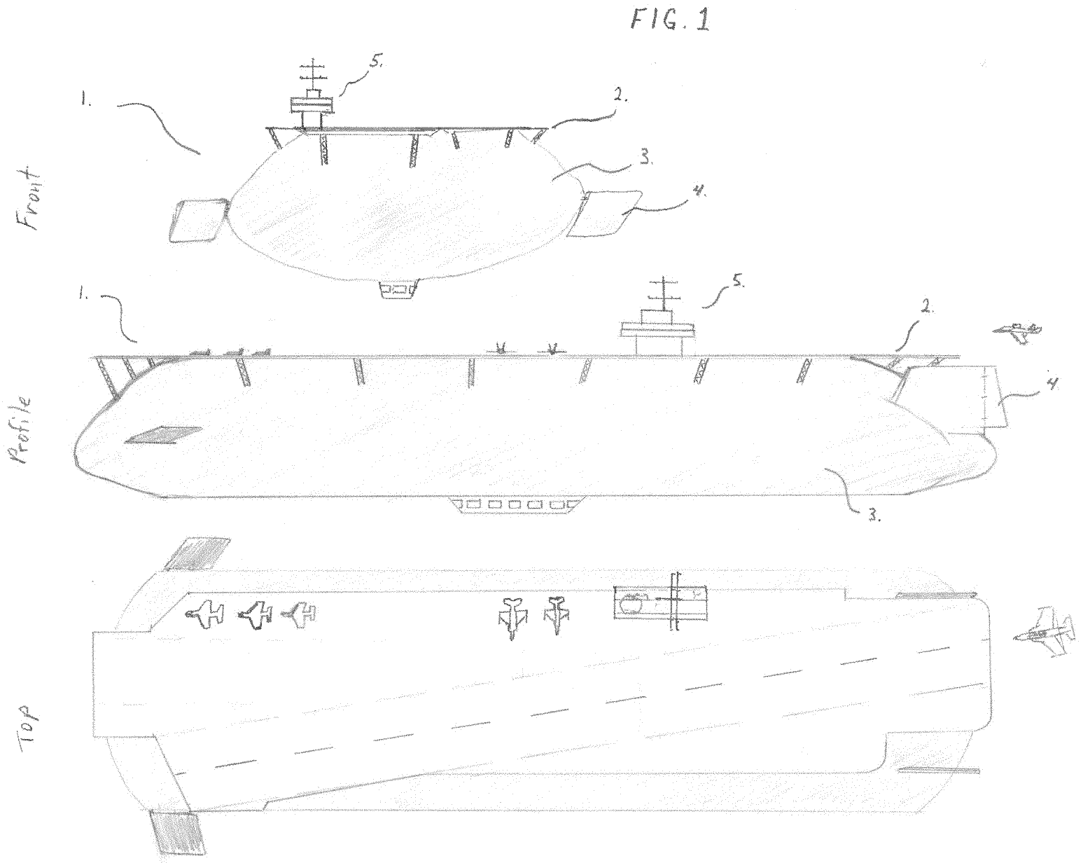

FIG. 1 is depicting one possible configuration of an illustrative embodiment of 1. an airborne platform vehicle that has the appearance of an “airship aircraft carrier” comprising 2. a long platform affixed to 3. an airship being capable of movement and remaining upright through the use of 4. propellers, ducted fans, vector thrusters, wings, fins, and/or rudders. This depiction shows 2. a long deck or platform in the form of a runway from which aircraft can land, refuel, re-arm, and take-off, 5. a control tower from which to oversee deck operations and which provides for an elevated platform for increased view as well as housing communication equipment.

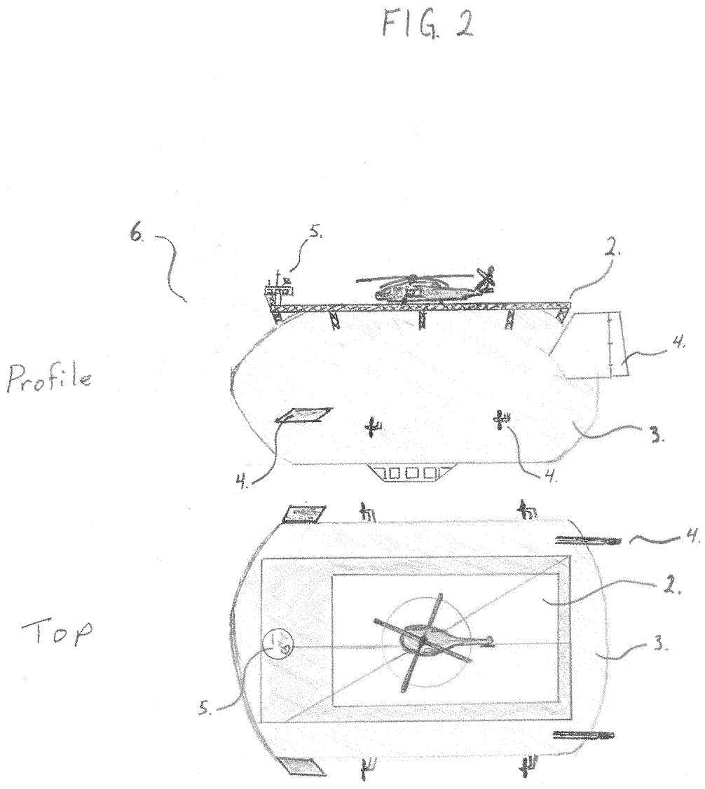

FIG. 2 is depicting one possible configuration of an illustrative embodiment of 6. an airborne platform vehicle that has the appearance of an “airship VTOL aircraft landing pad” comprising 2. a large platform affixed to 3. an airship being capable of movement and remaining upright through the use of 4. propellers, ducted fans, vector thrusters, wings, fins, and/or rudders. This depiction shows 2. a large platform from which vertical take-off and landing (VTOL) aircraft can land, refuel, re-arm, and take-off, 5. a control tower from which to oversee deck operations and which provides for an elevated platform for increased view as well as housing communication equipment.

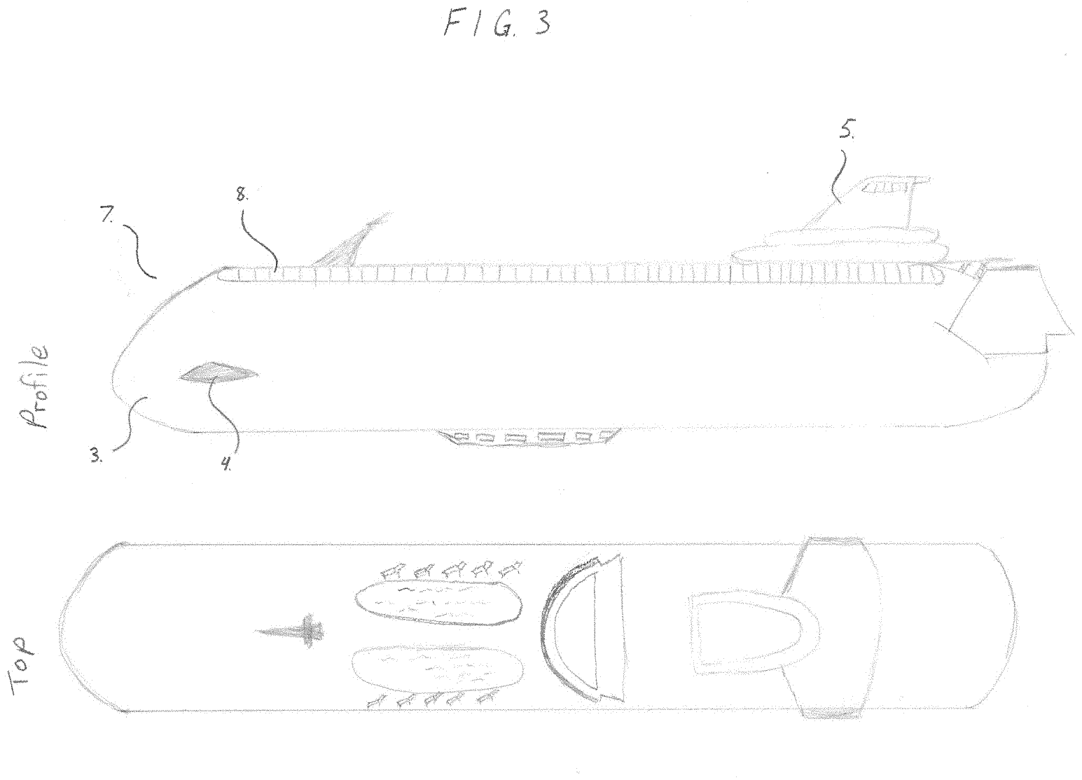

FIG. 3 is depicting one possible configuration of an illustrative embodiment of 7. an airborne platform vehicle that has the appearance of an “airship cruise ship” comprising 8. a large platform with cabins and other amenities for passengers affixed to 3. an airship being capable of movement and remaining upright through the use of 4. propellers, ducted fans, vector thrusters, wings, fins, and/or rudders. This depiction shows 8. a large deck for activities, recreational or otherwise, as well as cabins for transporting passengers, 5. a control tower from which to oversee deck operations and which provides for an elevated platform for increased view as well as housing communication equipment.

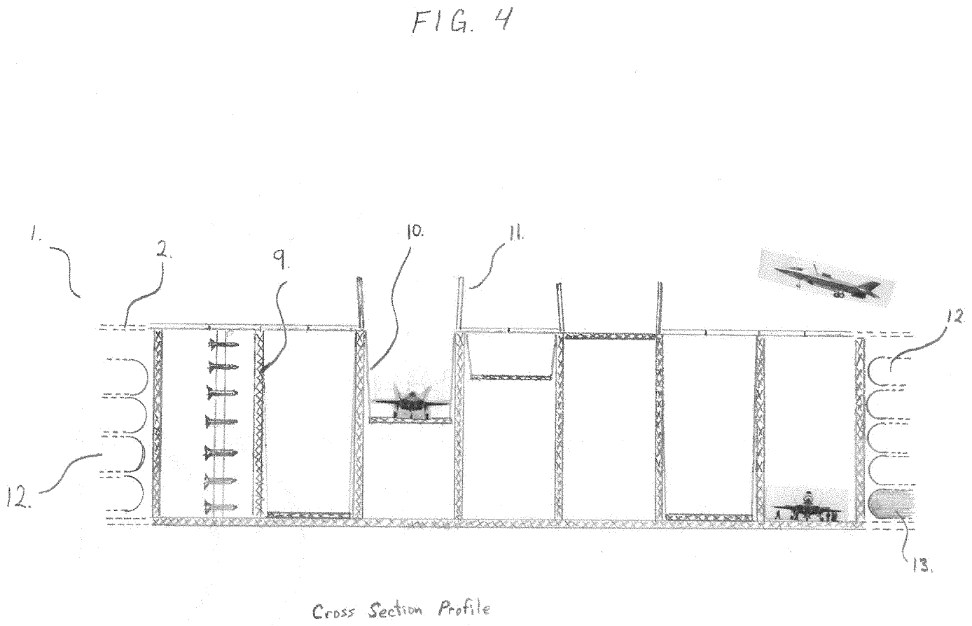

FIG. 4 is depicting one possible configuration of an illustrative embodiment of the cross-section of the interior view of 1. an airborne platform vehicle that has the appearance of an “airship aircraft carrier”. This depiction shows 9. engineered trusses to provide structural support to the shape of an airship body and 2. a large platform or deck used for various activities, which may also supports one or more control towers or raised platforms. This depiction also shows 10. lifts or elevators being used in aid of movement of cargo between levels of the airborne platform, 11. openings in the 2. platform through which cargo from below deck may be moved to the top of the platform made practical through moving doors, panels, sliding coverings, or otherwise. This depiction also shows 12. tanks, bladders, or balloons for lifting gas and 13. a power source for the propulsion system, be it internal combustion engine, battery, nuclear, gas, a hybrid, or otherwise.

1. An airborne platform vehicle comprising an aircraft with a platform affixed to the top side providing accessibility to the platform from outside the aircraft. The aircraft itself being able to float or fly by virtue of the lighter than air gas inside the body of the aircraft or with assisted lift from wings, being propelled by a ducted fan, vector thrusting, propeller drive system, or other forms of propulsion and having a power source from which to power the drive system. The airborne platform vehicle being capable of movement and remaining upright through the use of ballast, propellers, ducted fans, vector thrusters, wings, fins, and/or rudders. The airborne platform vehicle itself being able to take-off and land as well as stay afloat for long durations in a stationary or non-stationary position.

2. The airborne platform vehicle according to claim 1, wherein the platform is affixed to a rigid dirigible-like aircraft.

3. The airborne platform vehicle according to claim 1, wherein the platform is flat and performs the function of a top deck or runway upon which smaller aircraft may take-off, land, be transported, or perform other activities while on the platform.

4. The airborne platform vehicle according to claim 1, wherein the platform is able to secure aircraft while refueling, re-arming, repairing, recharging, or other activities are being conducted.

5. The airborne platform vehicle according to claim 1, wherein the airborne platform vehicle carries fuel, armaments, repair equipment, and batteries or recharging capability for refueling, re-arming, repairing, and recharging aircrafts, drones, and the like.

6. The airborne platform vehicle according to claim 1, wherein the platform is accessible from the aircraft's interior compartments below the surface of the platform.

7. The airborne platform vehicle according to claim 1, wherein the interior frame of the aircraft carrying the platform may have lifts (cable, hydraulic, or otherwise) to deliver items from the cargo areas below deck to the deck top side.

8. The airborne platform vehicle according to claim 1, wherein the platform is comprised of cabins for transportation of passengers.

9. The airborne platform vehicle according to claim 1, wherein the platform is comprised of amenities suitable for a recreational purpose.

10. The airborne platform vehicle according to claim 1, wherein the platform is comprised of structures, a covered roof or otherwise, to protect the platform from the elements.

11. The airborne platform vehicle according to claim 1, wherein the platform is comprised of structures aiding in surveillance, reconnaissance, or other military activities.

12. The airborne platform vehicle according to claim 1, wherein the platform is used for logistics in receiving, recharging, and launching drones delivering packages for civil, military, natural disaster, or other uses.

13. The airborne platform vehicle according to claim 1, wherein the platform is used for scientific research and study for meteorological, atmospheric, climatological, astronomy, terrestrial or celestial mapping, or other uses.

14. The airborne platform vehicle according to claim 1, wherein the platform is used to hold antennas, radar, satellite, receivers, and other telecommunication or wireless devices for providing global positioning system (GPS), cell phone reception, wireless internet, or other uses to a region surrounding the airborne platform vehicle.

15. The airborne platform vehicle according to claim 1, wherein the aircraft or airship has tanks, bladders, or balloons or lighter than air gas to provide or assist with lift of the aircraft.

16. The airborne platform vehicle according to claim 1, wherein the aircraft has a power source for the propulsion system, whether internal combustion engine, battery, nuclear, gas, a hybrid, or otherwise.

17. The airborne platform vehicle according to claim 1, wherein the platform still remains on top of the aircraft, but is sunken in to the aircraft allowing portions of the aircraft's sides to be higher than the platform to create a lower center of balance to assist with the airborne platform vehicle's stability.

18. An airborne platform vehicle comprising an aircraft with an interior platform accessible from opening rear and forward doors thereby providing accessibility to the platform from outside the aircraft. The aircraft itself being able to float or fly by virtue of the lighter than air gas inside the body of the aircraft or with assisted lift from wings, being propelled by a ducted fan, propeller drive system, or otherwise and having a power source from which to power the drive system. The airborne platform vehicle being capable of movement and remaining upright through the use of ballast, propellers, ducted fans, vector thrusters, wings, fins, and/or rudders. The airborne platform vehicle itself being able to take-off and land as well as stay afloat for long durations in a stationary or non-stationary position.

19. An airborne platform vehicle comprising an aircraft with a platform affixed to the bottom of it via cables, trusses, or other means providing accessibility to the platform from outside the aircraft. The aircraft itself being able to float or fly by virtue of the lighter than air gas inside the body of the aircraft or with assisted lift from wings, being propelled by a ducted fan, propeller drive system, or otherwise and having a power source from which to power the drive system. The airborne platform vehicle being capable of movement and remaining upright through the use of ballast, propellers, ducted fans, vector thrusters, wings, fins, and/or rudders. The airborne platform vehicle itself being able to take-off and land as well as stay afloat for long durations in a stationary or non-stationary position.
